(19) United States
(12) Patent Application Publication
(10) Pub. No.: US 2004/0244295 A1
(43) Pub. Date: Dec. 9, 2004

(54) Sash windows

(76) Inventors: Mike Derham, Essex (GB); John Hawker, Suffolk (GB); Timothy Allen, Dorset (GB)

Correspondence Address: Paul Remus, Devine Millimet & Branch, 111 Amherst Street, PO Box 719, Manchester, NH, 03105-0719, US

(21) Appl. No.: 10/485,875

(22) PCT Filed: Jul. 31, 2002
(86) PCT No.: PCT/GB02/03523

(30) Foreign Application Priority Data
Aug. 1, 2001 (GB) 0118824.2

(51) Int. Cl. E05F 11/34

(52) U.S. Cl. 49/362

(57) ABSTRACT

A sash window can be adapted for motorised operation using a rack and pinion drive. A preassembled motor unit (24) with a drive pinion (34) is mounted within one window stile (16). A rack (38) engages with the pinion and slides in a track (66) in the window stile. The window sash (14) which is to be driven up or down is connected to the rack through upper and lower hook mountings (48, 50), and the opposite side of the sash is free to travel between vertical guide surfaces.

This invention relates to sash windows, and to motor-driven apparatus for opening and closing such windows. Sash windows are also known as case windows, box windows, double hung windows or Colonial windows.

Various mechanisms have been proposed in the past in which motors have been used for opening and closing one or both sashes of a sash window. For example, British patents 2,242,225 and 2,318,384 both show schematic details of motor drive sash window mechanisms.

The manufacture of sash windows, and the renovation of existing sash windows is a task conventionally undertaken by carpenters and joiners who in general have little or no training or expertise in electrical and engineering skills. It is therefore desirable to make available the component parts for adding motor driven operation to a sash window, in a form which will be easy for such tradesmen to fit to an existing window or to fit as part of a newly manufactured window.

At the same time, the window with this equipment fitted should be easy to operate and smooth in action.

According to the invention, there is provided a motor driven sash window arrangement comprising a motor connected to a window sash through a rack and pinion arrangement whereby operation of the motor drives the sash for vertical sliding movement within a window frame and the engaging teeth of the rack and pinion lie in a plane parallel to the plane of the window sash.

Arranging the engaging teeth of the rack and the pinion to lie in a plane parallel (or substantially parallel) to the plane of the window means that the reaction force generated between the rack and pinion teeth acts at right angles to the window plane, and does not tend to drive the sash against the opposite side of the window frame.

The rack is preferably fitted in a guide track in the window frame, so that the reaction forces mentioned above are taken up between a face of the rack and a face of the guide track. The guide track can be an extruded section mounted in the window frame. The rack may be of a plastics material and the guide track of aluminium or an aluminium alloy.

The rack can be provided with hooked brackets and the adjacent edge of the sash with bracket-receiving pockets, so that the brackets can be received in the pockets to connect the sash to the rack. The rack may be provided with means (eg a series of spaced, tapped holes) whereby the brackets can be fixed to the rack at selected ones of a range of different possible positions. One bracket can have an upward facing hook and the other bracket a downward facing hook.

The arrangement preferably also has a control box connected to the motor with user-operable controls. The controls can be manually operable switches such as push-buttons, or can be operated from a separate remote control unit, for example an infra-red remote control.

The control unit preferably has a calibration mode which enables the length of movement of the window to be stored in the control unit after window installation.

The control unit can stop closing movement of the window before a fully closed position is reached, and require the operator to complete a second operation before the motor drives the window to a fully closed position.

The kit can include hooked brackets for fitting to the rack, and bracket-receiving pockets for fitting in the vertical edge of a window sash. A rack guide channel can be provided to be fitted in a groove in the window frame.

The rack can be sold in standard lengths and can be cut to length at the time of installation. The rack is preferably provided with means (eg a series of spaced, tapped holes) to which brackets can be fixed to the rack in selected ones of a range of different possible positions.

The motor unit is preferably a preassembled, sealed unit with a control unit. The control unit can have a calibration mode which enables the length of the movement path of the window to be stored in the control unit after window installation.

Operation of the motor may be by way of push buttons.

There may be one button for UP movement of the sash and another button for DOWN movement of the sash. The buttons may have to be kept pushed while the sash is moving, so that the motor stops if a button is released. Alternatively, there may be a control button which has to be operated in conjunction with either the UP button or the DOWN button, to operate the drive motor. It may be advantageous for the control button to be depressed only during the final movement of the sash into the fully closed position, as an additional safeguard against trapping a limb or other object in the window.

The invention also provides a method of converting a sash window to motor driven opening and closing operation, the method comprising the steps of forming a groove along one edge of a window frame, parallel to the direction of sliding movement of a window sash, mounting a toothed rack in the groove for longitudinal movement therealong, forming a recess in the window frame which communicates with the groove, mounting a motor unit in the recess so that an output member of the unit extends into the groove to engage with the rack, and connecting a window sash to the rack, so that the sash is moved longitudinally when the rack is driven along the groove by the motor.

The window sash is preferably only connected to the window frame along one vertical edge, the opposite vertical edge having no positive connection with the window frame.

The rack can be provided with two vertically spaced hooked brackets, with the sash being hung on those brackets. A peg can be inserted through the window sash frame and the brackets, to prevent accidental disengagement of the sash and the brackets.

A guide channel can be mounted in the groove, with the rack being fitted in the channel for guidance therealong.

A calibration step can be carried out on completion of window installation. In this step, the sash is moved from its fully open position to its fully closed position (or vice versa) and the length through which the sash moves is stored. Thereafter a motor control unit uses the stored value to control the movement of the sash towards its end positions.

In yet another aspect, the invention provides a motor driven sash window arrangement comprising an electrically driven motor connected to a window sash to drive the sash in sliding movement within a window frame, wherein the motor includes a control unit which has a set up mode in which the sash is driven to opposite ends of its travel in the frame, and the control unit stores those end positions so that, upon exiting the set up mode, the motor can drive the sash to an end position, and will then stop.

The motor may slow down as the sash approaches the end of its travel, and may stop at a position where the window is nearly opened or nearly closed, whereupon further operator action is required to completely close or open the window.

The motor may be arranged so that it stops if it senses an obstruction to further opening or closing movement. This may be achieved by including a proximity detector arranged at an end position of window movement, which stops window movement if an obstruction is sensed.

The control unit can have a switch for UP movement and a switch for DOWN movement, and the switches may be of the type which has to be manually held closed to keep the motor running.

The invention applies to any window frame with at least one motorised sash. A window might have one or two or even more motorised sashes. The window might have other sashes which are fixed or which are movable under conventional pulley and weight control.

The invention also provides a kit for providing motor driven opening and closing operation to a sash window, the kit comprising a toothed rack, means for connecting the rack to a vertical edge of a window sash for sliding movement with the window sash, a motor unit contained within a housing, which unit can be inset into a recess in a window frame adjacent the path of movement of the sash and the rack and having an output member in the form of a pinion adapted to engage with the rack so that operation of the motor unit rotates the pinion which in turn drives the rack in a linear path with the sash being raised or lowered as the rack is driven, and a rack guide channel for mounting in a stile of the window frame, for slidably receiving the rack

The kit can include a plurality of identical lengths of rack, with means for joining lengths end to end to make a rack longer than a single length. Each length of rack can have a series of spaced, tapped holes into which brackets can be fitted.

The motor unit can be a preassembled, sealed unit, and can include a control unit with a calibration mode which enables the length of movement of the window to be stored in the control unit after window installation.

The invention will now be further described, by way of example, with reference to the accompanying drawings, in which:

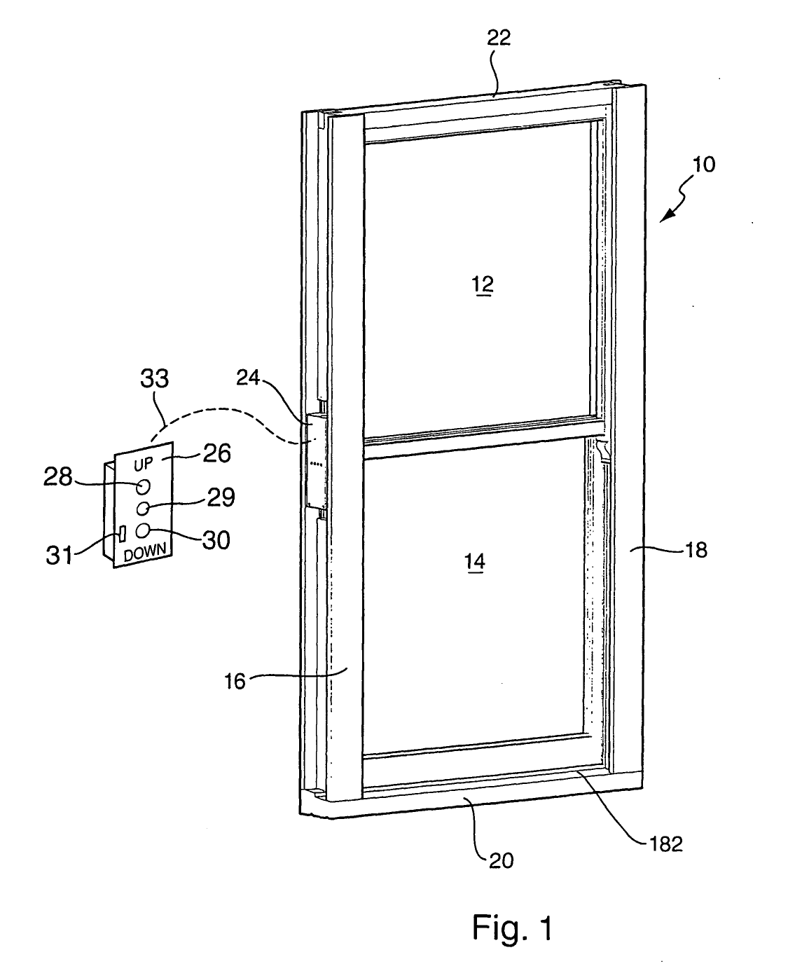

FIG. 1 is a perspective view of a sash window in accordance with the invention;

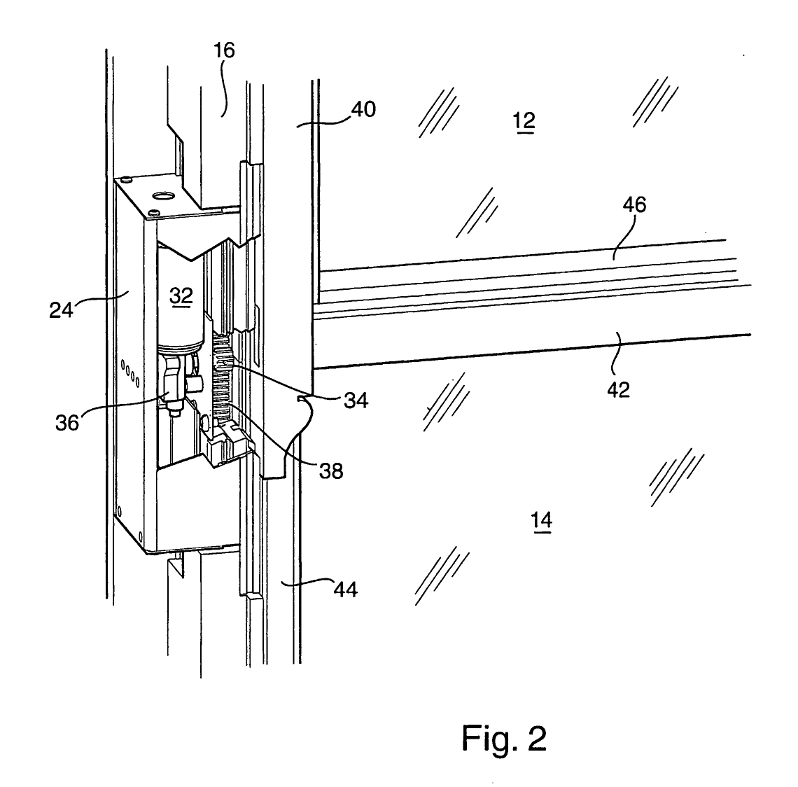

FIG. 2 is a perspective view, partly broken away, of part of the window of FIG. 1;

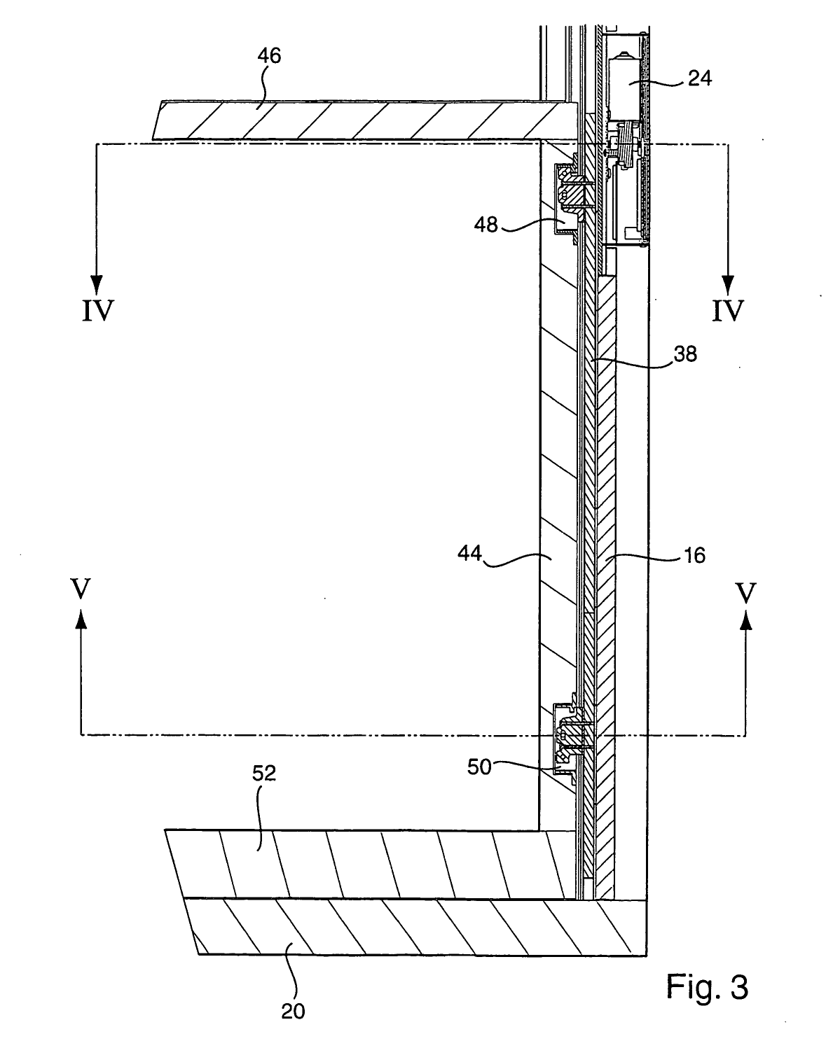

FIG. 3 is a section through a part of the window of FIG. 1;

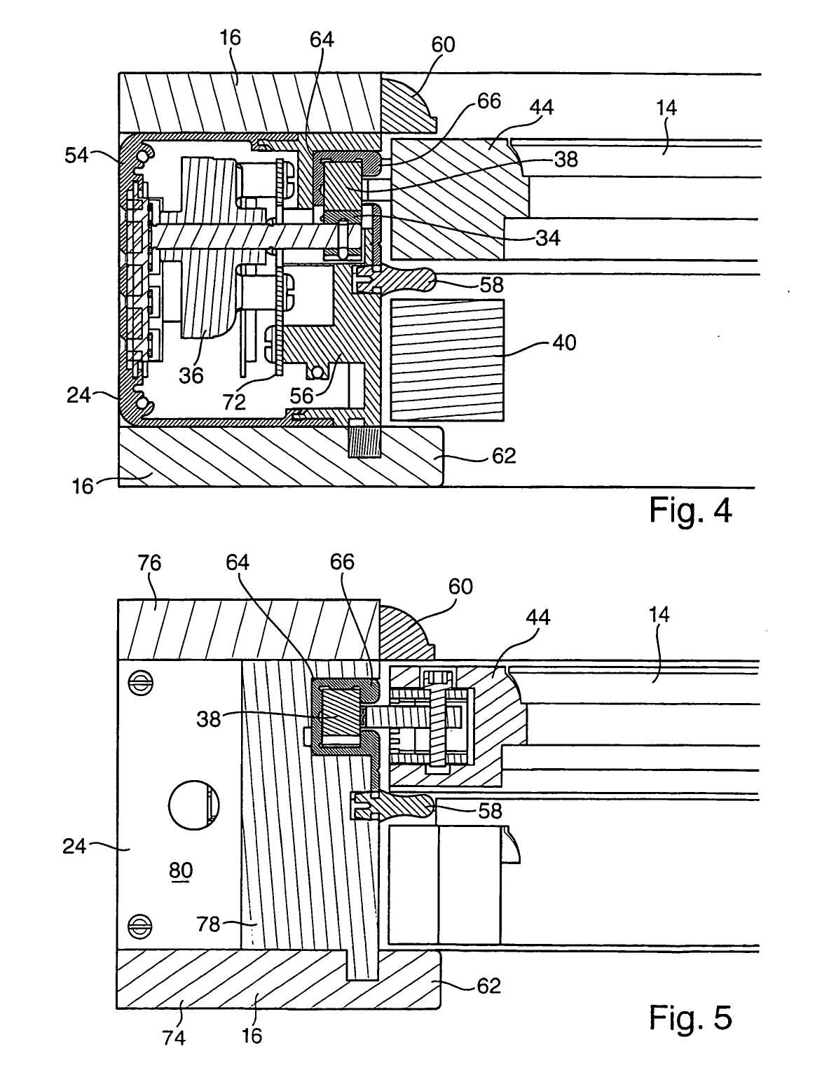

FIG. 4 is a section on the line F-F from FIG. 3;

FIG. 5 is a section on the line G-G from FIG. 3;

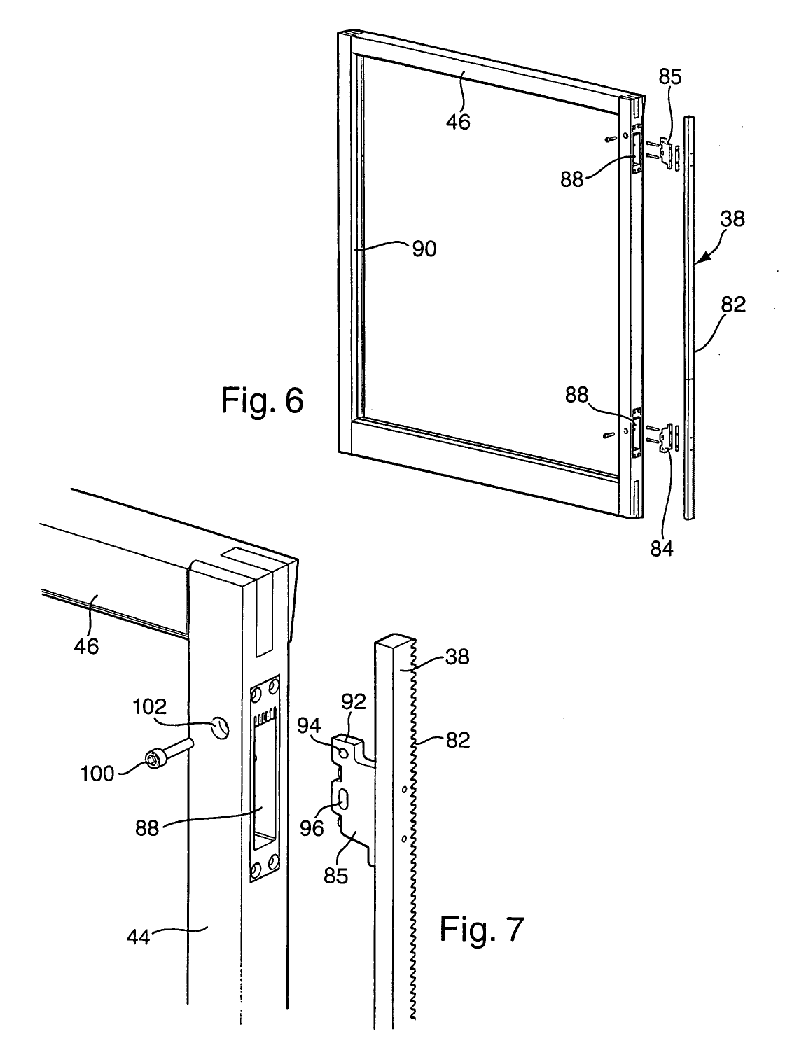

FIG. 6 is a perspective view of certain components of the window, in an exploded condition;

FIG. 7 is a detail view of part of FIG. 6;

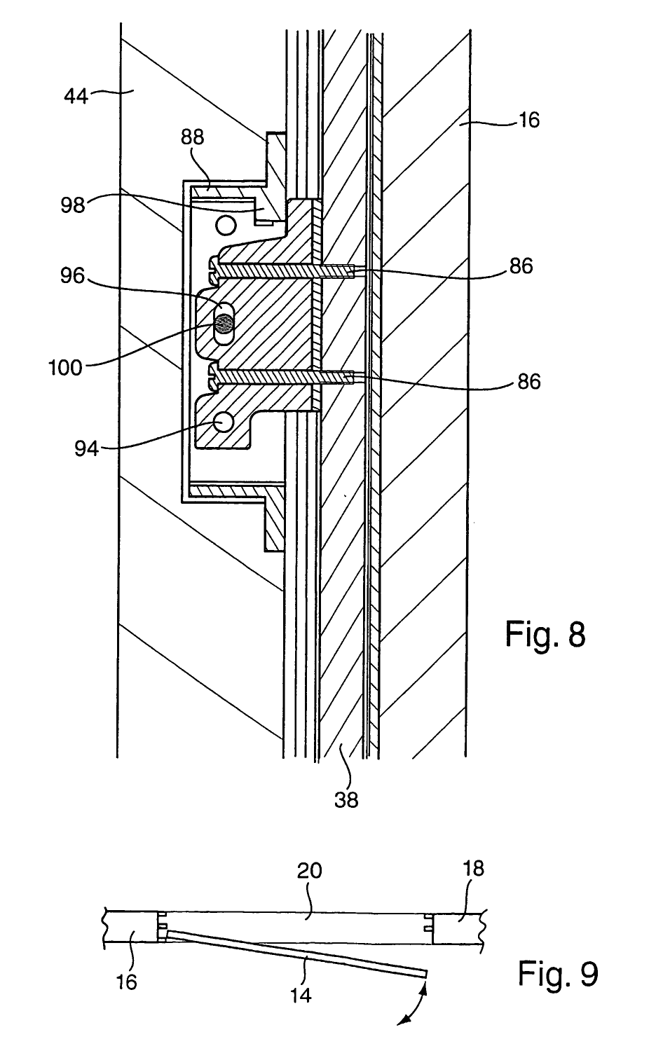

FIG. 8 is a section through that part of the window shown in FIG. 7;

FIG. 9 illustrates how a sash can be offered up to a window frame; and

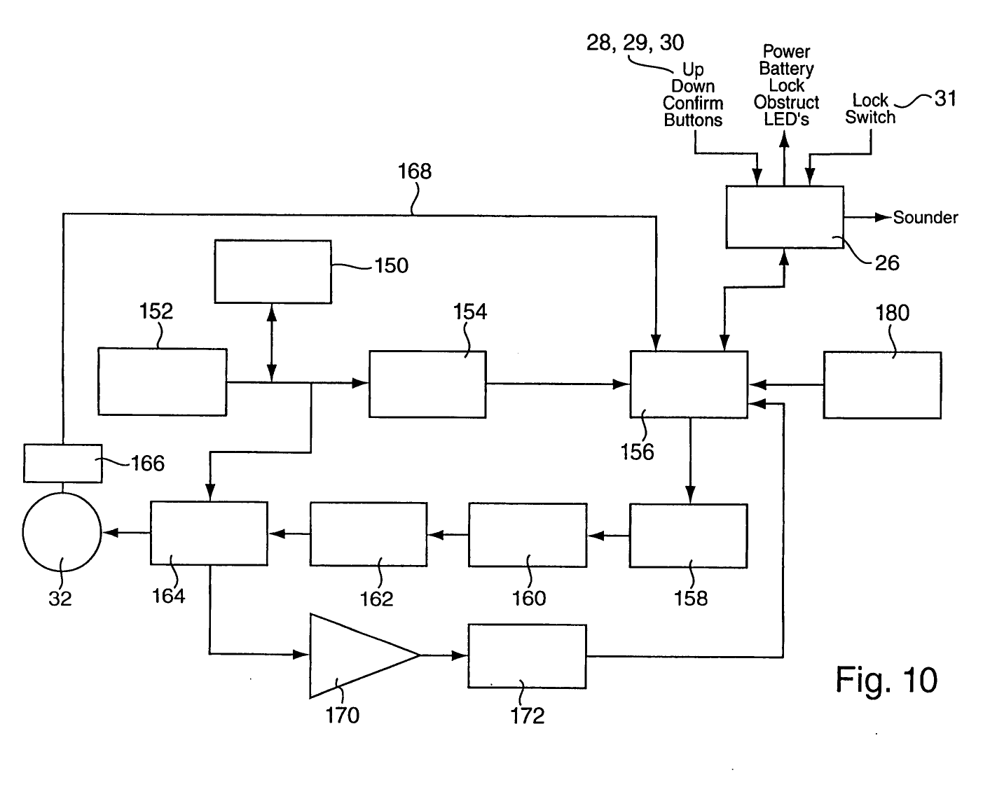

FIG. 10 is a schematic diagram illustrating the control system for operating a window in accordance with the invention.

FIG. 1 shows a window with a frame 10 and top 12 and bottom 14 sashes which can move vertically in the frame in a conventional manner. The frame has vertical members (stiles) 16 and 18, a sill 20 at the bottom and a cross-member 22 at the top. The window frame and the individual sash frames will be made of wood, using conventional construction techniques for these components. The invention is not however limited to the use of wood, and the principles and details which will be described below will be applicable whatever the material of the frames.

A motor box 24 is mounted in the stile 16. An electric motor housed in this box is arranged to drive the lower sash 14 between its closed position shown, and an upper position where it substantially overlaps the upper sash 12. When the window is fitted in the wall of a building, the outwardly facing surfaces of the frame member (including the face through which the motor box 24 can be seen in FIG. 1) will be built in to the wall, so that the motor box will be out of sight.

If both sashes are to be motorised, a second motor box 24 will be fitted on the opposite side of the window frame, to operate the other sash.

Electrical connections (not shown in FIG. 1) will be made to the motor box 24, both to provide power to drive the motor (directly, or indirectly through a battery), and to carry control signals which determine the operating movements of the motor.

FIG. 1 also shows an independent switch unit 26 which can be mounted on a wall alongside the window (or could possibly be integrated into the window frame). The switch unit has an UP button 28, a DOWN button 30 and a SAFETY button 29, and the appropriate button will be pressed by a user to raise or lower the sash 14. Electrical connections will be made between the switch unit 26 (which will house a battery for driving the motor) and the motor box 24. If both sashes are motorised, there could be two independent switch units, or the two sashes could both be operated from appropriate buttons on a single switch unit.

FIG. 2 shows the inside of the motor box 24 (which could be a die casting or a moulding), with an electric motor 32 driving a pinion 34 through a gearbox 36. The pinion 34 and its shaft 70 can be formed integrally from a single piece of metal, and the pinion itself meshes with a rack 38 which is mounted on the lower sash 14, as will be described below. In FIG. 2, the upper sash 12 is shown in front of the lower sash 14. The upper sash has a vertical frame member 40 and a horizontal frame member 42. The lower sash has a vertical frame member 44 and a horizontal frame member 46.

The motor box 24 also houses an electronics unit which controls the manner in which the motor 32 drives the sash 14 and a storage battery (150—FIG. 10) which provides the electrical current to operate the motor 32.

The rack 38 (see FIG. 3) extends alongside the sash 14 and is connected to the sash at two points 48 and 50. FIG. 3 also shows the lower horizontal frame member 52 of the lower sash. Rotation of the pinion 34 by the motor 32 results in the rack 38, and with it the sash 14 being raised and lowered past the position of the motor box 24.

FIG. 4 is a horizontal section through the motor box 24. The box 24 itself (in the example shown) comprises two mating extruded sections 54 and 56. The front section 56 has a groove to receive a parting bead 58.

Mouldings 60 and 62 constrain the two sashes 12 and 14 to move only in a vertical plane. The front section 56 also includes a groove 64 which receives an elongate rack guide channel 66. The guide member is received in the groove 64 with most of its length fitted above and below the position of the motor box, in the groove 64 in the wooden stile 16 (see FIG. 5).

When the motor is driven, the engagement between the pinion teeth and the teeth on the rack raises or lowers the rack (depending on the direction of rotation) and also generates a force tending to push the rack and the pinion apart. This latter force is absorbed between the rear face 38a of the rack and the facing surface 66a of the guide channel 66, and none of this force is transferred to the sash itself.

The gearbox 36 and its output shaft 70 can be seen in FIG. 4. The gearbox is mounted on a plate 72 and the plate 72 is in turn mounted on the back section 56 of the motor box 24.

FIGS. 5 to 8 show how the rack 38 is connected to the sash 14.

FIG. 5 shows a section through the stile 16 below the motor box 24. At this position, and indeed through the height of the stile, the stile has two cheeks 74, 76 joined by an upright member 78 (except where the upright member is cut away to accept the box 24). The groove 64 is cut in the upright member 78. In FIG. 5, which is a view looking upwards along the stile 16, the bottom face 80 of the motor box 24 can be seen.

The connection between the rack 38 and the sash which the rack has to lift is critical. Because, in most cases, the sash and window frame will be made of wood, there will be a degree of dimensional variation which has to be accommodated, as a result of swelling or shrinkage of the wood according to climatic conditions. Furthermore, windows have to be painted and repainted during their lifetime, and the motor drive has to continue operating without being adversely affected by such changes.

The rack 38 (see FIGS. 6 and 7) has teeth 82 on one face and has another face, at right angles to the toothed face, to which suspension brackets 84,85 are mounted by means of screws 86 (FIG. 8). The sash frame has slots rebated into the wood, and pockets 88 which are fitted into those sockets. The pockets 88 (which may be plastics mouldings) are located near to the top and the bottom of the sash, so that they can control tilting or skewing of the sash in its own plane. The opposite edge 90 of the sash is guided between a parting bead 58 and a moulding 60, but is otherwise independent of the stile 18, and is to be held out of contact with the inward facing surface of the post (corresponding to upright member 78) of the stile 18.

The rack can be of plastics or metal.

The brackets 84,85 have hooks 92 at one edge, and two through bores 94,96. The bracket 85 has its hook facing upwards, and the bracket 84 has its hook facing downwards. As can be seen in FIG. 7, the hook 92 of the upper bracket 85 engages behind a lip 98 of the pocket 88, so that the sash can be easily placed on and can hang from this bracket 85. The lower bracket 84 projects into the respective pocket 88 and provides lateral location to the sash. To achieve the correct vertical positioning of the sash, and the correct spacing from the window frame, spacers 87 of appropriate thickness are fitted between the brackets 84,85 and the rack 38.

Once the sash has been hung on the brackets a peg 100 is inserted through holes 102 on the sash frame and on the pockets 88, and through the elongated hole 96 on the bracket. The holes 96 are elongated so that any tolerances in the positioning of the pockets 88 can be accommodated. The pockets 88 are wider than the brackets 84, so that the brackets and pockets can be engaged with one another when the window sash is held at an angle to its final position in the frame.

The sash can be hung on the brackets 84,85 with the sash swung out of the plane of the window frame, as shown in FIG. 9. Once the sash has been hung, it can be swung into the plane of the frame as indicated by the arrow 89, and the moulding 60 can be fitted around the frame to provide vertical guides for the sash.

There is sufficient spacing between the various components attached to the sash and components connected to the motor to allow the sash to take up a position within the frame which ensures that it can slide freely up and down in the frame.

The side of the sash opposite to the side connected to the rack can slide freely between a parting bead and a moulding, on the opposite side of the frame. However if the sash is particularly heavy, a conventional sash weight or spring sash balance can be used on that side, to counterbalance the weight of the sash.

Sash windows are conventionally constructed and maintained by people with joinery and woodworking skills. The present invention aims to make it practical for people skilled in the making of sash windows to modify those windows (either during new construction or through renovation of the existing windows) to motorised operation.

To convert a conventional sash window for motorised operation in the way described in the specification, the following steps are necessary:

The sashes are removed from the window frame.

A recess is cut in one stile to accept the motor box 24.

A groove is rebated the full length of the stile which is to hold the motor box, to accept the rack guide channel 66.

Two slots 48, 50 are rebated in one vertical edge of the sash or sashes which is/are to be lifted.

Pockets 88 are inserted into those sockets and fastened in place.

A rack 38 of length generally equal to the intended extent of lifting movement has brackets 84 fixed to it and is fitted in the channel 66.

A pre-assembled motor box 24 is inserted in the cut out in the stile 16 so that the pinion 34 and the rack 38 engage with one another.

The moveable sash or sashes are hung on the brackets 84. At this stage the moulding 60 is absent so that the sash can be offered up to the brackets 84 out of the plane of the window frame (see FIG. 9).

The sash is swung into place in the window frame and moulding beads 60 are attached to the frame.

To adapt a sash window for motorised operation, the window manufacturer/repairer will purchase a kit which will contain a pre-assembled motor box 24, a length of guide channel 66, a length of rack 38, two brackets 84 and two pockets 88 (together with associated fastenings).

The length of the rack 82 and guide channel 66 will depend upon the dimensions of the sash to be raised. However, it will be quite possible for the rack and the channel to be sold in standard lengths of, say, 1 metre and for additional lengths of these two components to be available to the fitter. It will be clear that the channel 66 does not need to be one continuous length of material. Two lengths of the same cross-section could be used, with the ends of the two lengths simply butted up against one another and retained in place through their mounting in the frame.

Similarly, the rack 38 could be made in more than one piece and indeed FIG. 6 shows a rack made up of two pieces which are joined somewhere along their length. The joining of these two sections of rack needs to be sufficiently strong to allow some of the lifting forces to be transferred across the joint, but suitable joining methods will be provided with the extension lengths of rack.

The rack 38 will have drilled and tapped holes spaced regularly along its entire length, to receive bracket holding screws 86 at any appropriate position.

To prevent the window sash from skewing in its own plane, the brackets 84,85 should be placed as far apart as possible on the vertical edge of the sash.

It is the intention that the sash should at all times remain out of contact with the upright members 78 on the two opposite stiles.

In addition to the fitting of the components so far described, electrical connections also have to be made and it is desirable to provide the kit of parts with electrical connections which require the minimum of electrical knowledge to install them. The window will ultimately require a connection to the electrical mains, but the system can be set so that the window installer can complete his work and leave a single set of wires for later connection by an electrician to a mains supply.

As already mentioned, the window will be operated by the user from an operators panel 26. In principle, the controls available to the user will be an UP button and a DOWN button. The control box 26 can also have an isolation switch which can be operated before an electrical storm to prevent a malfunction of the control box processor from incorrectly opening a window in a storm.

Once the mechanical installation of the motor drive is complete, a calibration has to take place. Sash windows come in widely differing sizes, and therefore the length of travel between the open and closed positions will need to be set individually for each window.

It is, therefore, proposed that the window installer will, as a final stage of the installation, calibrate the window so that the electronics contained in the control box 26 and/or in the motor box 24 will store the distance which is to be moved between open and closed positions. The end positions are detected by driving the motor until it stalls; in this situation the motor current rises rapidly which is interpreted as an ‘end of travel’ signal.

A benefit of knowing the length of travel distance between fully open and fully closed positions is that it allows a determination of whether a stall is due to reaching the open or the closed position or an obstruction. Also it allows the window to stop at a precise distance from the closed position, at which point the operator must re-press the DOWN button or press two of the buttons 28,29,30 simultaneously to complete a window closing operation. An audible alarm can sound during this final stage of closure.

The motor 32 is controlled by a microprocessor and associated electronics. A block diagram of the system is shown in FIG. 10 and the constituent blocks are described below. The main electronics is contained in the motor enclosure 24 and is connected via an umbilical cable 33 to the wall-mounted control panel 26. The control panel contains push-buttons 28,29,30, LED's, an audible sounder and a lead-acid battery 150.

The primary source of power for the controller is the battery 150. The drive motor 32 is a 12 Volt automotive type and this type of battery is able to provide high currents for short durations, while remaining compact and cost-effective. A further reason for using battery power is to ensure that the powered window can still be operated in the event of a mains power cut. This is particularly important in the event of fire. The lead-acid battery is trickle-charged from the mains by a low-power mains charging circuit (within 152).

A 5 Volt regulator 154 converts the nominal 12 Volt battery supply to 5 Volts in order to power the electronics. Current requirement of the 5 Volt electronics is of the order of 50 mA.

The drive voltage required when the motor lifts the sash is much greater than when lowering it, and so a variable drive voltage is required. This can be achieved with high efficiency with a high frequency pulse train of variable duty cycle. The motor 32 averages the applied voltage and sees only the mean DC component of the waveform. This technique is called Pulse Width Modulation (PWM) and takes place in a PWM generator stage 158. A microprocessor generates the necessary signals for the PWM drive.

Since it is a requirement that the motor be driven in both directions, a power output stage 164 comprising four MOSFET's in a H-bridge configuration is used. The topology lends itself to PWM drive. Power MOSFET's are highly efficient when used as switching components and are the components of choice for this application.

The power MOSFET's used in the H-bridge must themselves be driven by circuits capable of sourcing and sinking high peak currents. Voltage level translation is also required. Dedicated MOSFET drivers 162 are used for this purpose.

It is necessary to underlap the drive signal to the MOSFET power output stage in order to avoid brief time periods when two devices in the same arm of the H-bridge are conducting simultaneously. If this is allowed to occur, the 12 Volt power supply would be momentarily shorted, causing high current spikes to flow, leading to reduced efficiency and high radiated and conducted noise. A skew circuit 160 provides underlap to prevent this happening.

The motor 32 has an integral shaft encoder 166 which generates a fixed number of pulses per revolution. This provides a feedback signal (via connection 168) of the instantaneous motor speed which permits the implementation of a closed-loop feedback control system for motor speed. Such a controller is implemented in the microprocessor software and automatically compensates for variations in motor loading caused by window weight, whether it is being raised or lowered, and local variations in sliding friction as the window moves. A further benefit is that the control system is able to monitor the position of the window. This is important for safety reasons.

A current sense amplifier 170 and low-pass filter 172 allow the microprocessor 156 to continually monitor the motor current. This is achieved by including a low-value current sensing resistor in the ‘tail’ of the H-bridge. The voltage induced across this resistor is then proportional to the motor current. This voltage is then amplified and filtered to a suitable level for the microprocessor. The current is monitored for the following reasons:

1. End-of-travel detection. On reaching the top or bottom of the frame, the motor stalls and the motor current rises sharply. The microprocessor, by monitoring this current, is able to detect that the window has reached its fully open or fully closed state and thus de-energise the motor. This obviates the need for additional limit switches to detect end-of-travel.

2. Detection of an obstruction. The microprocessor knows what the typical running current of the motor should be while raising or lowering the window (these currents are very different and must be characterised independently as part of a calibration process). If an increase in current is detected, the motor can be immediately stopped. If desired, the microprocessor can briefly reverse the direction of motor drive. Thus a trapped limb can be detected and freed.

Current overload detection as described above has limitations if it is to be used to detect trapped limbs. The primary requirement on the motor is that it be capable of raising and lowering a window of up to 50 kg in weight. Even when lowering such a window, there is a significant load torque resulting from frictional losses in the drive train. Furthermore, it is important to minimise false detection of a current overload condition caused by warping or swelling of the window and frame. Thus, the current overload trip level cannot be made too sensitive. There is therefore the possibility that injuries to small appendages such as fingers could be sustained before the current overload reached its trip point.

A capacitive proximity detector 180 is therefore proposed to be included as part of the installation. This can consist of a metallic sensing strip 182 (FIG. 1) let into the bottom of the window frame and connected to an electronic sensing circuit. When this strip is touched (or almost touched), a signal is produced which prevents the window being operated.

The control electronics is microprocessor-based and interprets input signals (Up and Down controls, current sense input etc.) and generates the control signals for the PWM generator. The Up and Down signals in their simplest form are derived from the operation of push buttons 28, 30 but could also be sourced from an infra-red, radio or mains-signalling receiver.

The following are key aspects of the control system, which is implemented in software on the microprocessor:

### A. Closed-Loop Speed Control

As described earlier, the load torque when raising the window is substantially greater than when lowering the window. If the motor was driven by the same voltage, we would therefore expect the lowering speed to be significantly faster than the lifting speed. Furthermore, different sizes of windows with different weights will vary the degree of this effect. The use of a motor with a shaft encoder allows the use of a closed-loop speed control algorithm. This gives excellent control which is completely independent of direction of travel or window weight. The only requirement is that the motor and battery are capable of delivering the power necessary to move the window at the desired speed.

### B. End-Of-Travel Detection

End of travel detection is necessary to prevent the motor and/or electronics burning out if someone holds down either of the buttons and stalls the motor. Although limit switches can be used for this purpose, they are not favoured because of the additional work involved in installing them. Furthermore, limit switches do not protect against the window seizing halfway through its travel. End-of-travel detection is therefore implemented by a current overload detect circuit. This stops the motor when a specified current threshold is exceeded. There are a number of issues which must be addressed in the design of the end-of-travel detection:

1. A ‘dead-time’ must be allowed immediately after energising the motor so that the start-up current is ignored. Otherwise, the circuit will immediately trip out the motor before it has started to move.

2. The threshold will be different when raising or lowering the window, because clearly when raising the window, the motor current is higher due to the increased load.

3. Different sizes of window require different current thresholds. The thresholds are determined during installation as part of a calibration procedure.

4. The use of a shaft encoder allows the control system to monitor the position of the window. By using this information, it is able to differentiate with reasonable confidence whether an overload condition is due to the window reaching the end of travel or some other obstruction, simply by confirming whether a overload condition occurred at or close to an expected end-of-travel position. The type of shaft encoder used is a relative type, which is able to measure a number of motor revolutions, and hence distance, from a datum. Two types of relative shaft encoders are available, single channel and quadrature. A quadrature encoder provides directional information as well as displacement, but is more costly. A single channel encoder simply generates pulses as the motor shaft rotates. Since the control system knows implicitly which direction the motor is running, a single channel encoder sufficient in this application. However, cumulative errors, albeit small, occur on direction changes with a single channel encoder. Thus it is important that the system is re-indexed on reaching the end-of-travel. This simply means that on reaching the end-of-travel, the position variable is discarded and reloaded (with zero if the window is fully closed, or with the travel distance if fully open).

### C. Calibration

The system requires calibration in order to accommodate variations in the following parameters:

1. Variations in window weight and sliding friction. These affect the current requirements of the motor and are different depending on whether the window is being raised or lowered. The motor current must therefore be measured twice: when raising and when lowering the window. These run currents are then used to determine two current overload trip levels, one for raising and one for lowering the window.

2. Window opening distance. This is required so that end-of-travel detection can be implemented. There are safety benefits in combining end-of-travel detection with a knowledge of actual travel distance, as discussed later.

A calibration procedure could be as follows:

1. Ensure the window is positioned at or near the fully lowered position.

2. Press the buttons in a predetermined sequence to enter calibration mode.

3. Press and hold the “up” button. Release when the window has moved by 12 inches. This allows the unit to measure the typical “up” motor current.

4. Press and hold the “down” button. Release when the window has moved by 12 inches. This allows the unit to measure the typical “down” motor current.

5. Press and hold the “down” button until the window stalls out against the bottom of the frame.

6. Press and hold the “up” button until the window stalls out against the top of the frame. The controller now knows the window travel.

### D. Automatic Battery Testing

It is important that the condition of the battery is periodically checked, as the system could be subjected to long periods of inactivity, but may then be required to open a window in an emergency (for example in a fire).

While the window is fully closed, the controller tests the battery by switching on the motor drive in the closed direction for several seconds (such that the motor is stalled) while monitoring the battery voltage. If the voltage falls below a predetermined threshold, the unit alarms with a ‘replace battery’ alert (LED and sounder).

### E. Lock Switch

Included on the control panel can be a slide or toggle type switch 31, which when set in the “Lock” position disconnects the microprocessor from the motor drivers. This ensures that in the event of a processor failure the windows cannot move. It is anticipated that this switch would be used when a house is empty for long periods (vacation time) or in locations where lightning or other major electrical disturbances may be prevalent.

### F. Additional Safety Features

The following safety features are designed to minimise the risk of injury caused by closure of the window onto body parts:

1. The control panel includes three buttons: Up, Down and Confirm. The Confirm button must be pressed simultaneously with either of the other buttons in order for the window to move.

2. In all situations, window movement stops immediately the buttons are released. To maintain window movement, the buttons must be held down.

3. When the window reaches 15 cm from the fully closed position, it stops. To continue to the fully closed position, the Down and Confirm buttons must be released and then pressed again.

4. An overload condition immediately causes the motor to stop. If the overload occurs within close proximity (say 2.5 cm) of the expected end-of-travel position, the internal position variable is updated (re-indexed) as the window is assumed to have stalled out against the frame. Otherwise, the motor direction can be briefly reversed to free an obstruction.

5. The window cannot be operated until the calibration procedure has been carried out.

### G. Control Panel

The control panel, which is designed to be wall-mounted near to the window which it operates, includes the following:

| | |
|---|---|
| “Up” Button | Pressing this simultaneously with the |
| | “Confirm” button raises the window. |
| “Down” button | Pressing this simultaneously with the |
| | “Confirm” button lowers the window. |
| “Confirm” | Provide “two-fingered” operation for |
| button | increased protection against inadvertent |
| | use or children. |
| “Lock” switch | Slide or toggle switch which disables |
| | controller. |
| “Power” LED | On when mains power present. Flashes if |
| | no mains power (sounder also beeps every |
| | minute). |
| “Replace | Flashes when battery requires |
| Battery” LED | replacement. Sounder also beeps every |
| | minute. |
| “Lock” LED | Lights if “Lock”switch is on. Trying to |
| | operate the window when the “Lock” switch |
| | is on causes this LED to briefly flash |
| | and the sounder to beep. |
| “Obstruction” | Lights if proximity detector activated. |
| LED | Sounder beeps and window stops if window |
| | was already moving. |
| Sounder | Piezo-type acoustic beeper. |
| Lead-Acid | The Lead-acid battery is concealed behind |
| Battery | the control panel, for ease of |
| | maintenance. |

### Summary Of Key Features

1. Closed loop feedback motor control for constant speed operation.

2. Precise tracking of window position.

3. Current monitoring for end-of-travel and obstruction detection.

4. Automatic battery condition monitoring for reliable operation.

5. Proximity detection of body parts for prevention of crushing or severing injuries.

6. Lock switch for added security during periods of non-use.

7. Calibration to specific installation: window travel and running current.

It is to be noted that the gear ratios in the gear box 36 will be such that the weight of the window cannot drive the motor in reverse, ie when the motor is stopped in any position, the window will stay there until the motor is energised again.

The arrangements described here for sash window operation allow simple installation and reliable operation of motorised sash windows.

1. A motor driven sash window arrangement comprising a motor connected to a window sash through a rack and pinion arrangement whereby operation of the motor drives the sash for vertical sliding movement within a window frame and the engaging teeth of the rack and pinion lie in a plane parallel to the plane of the window sash.

2. A sash window arrangement as claimed in claim 1, wherein the rack is connected to a vertical edge of the window sash, and a guide track for the sash is provided in the window frame.

3. A sash window arrangement as claimed in claim 2, wherein the guide track is an extruded section mounted in the window frame.

4. A sash window arrangement as claimed in claim 2, wherein the rack is of a plastics material and the guide track is of aluminium or an aluminium alloy.

5. A sash window arrangement as claimed in claim 1, wherein the rack is provided with hooked brackets and the adjacent edge of the sash is provided with bracket-receiving pockets, the brackets being received in the pockets to connect the sash to the rack.

6. A sash window arrangement as claimed in claim 5, wherein the rack is provided with means whereby the brackets can be fixed to the rack at selected ones of a range of different possible positions.

7. A sash window arrangement as claimed in claim 6, wherein the rack is provided with a series of spaced, tapped holes through which brackets can be attached to the rack in any selected positions.

8. A sash window arrangement as claimed in any claim 5, wherein one bracket has an upward facing hook and the other bracket has a downward facing hook.

9. A sash window arrangement as claimed in claim 1, wherein a control box connected to the motor has user-operable controls.

10. A sash window arrangement as claimed in claim 9, wherein the controls are manually operable switches such as push-buttons.

11. A sash window arrangement as claimed in claim 9, wherein the controls are operated from a separate remote control unit.

12. A sash window arrangement as claimed in claim 1, including a control unit with a calibration mode which enables the length of movement of the window to be stored in the control unit after window installation.

13. A sash window arrangement as claimed in claim 12, wherein the control unit stops closing movement of the window before a fully closed position is reached, and requires the operator to complete a second operation before the motor drives the window to a fully closed position.

14. A method of providing motor driven opening and closing operation to a sash window, the method comprising the steps of forming a groove along one edge of a window frame, parallel to the direction of sliding movement of a window sash, mounting a toothed rack in the groove for longitudinal movement therealong, the rack teeth lying in a plane substantially parallel to the plane of the window, forming a recess in the window frame which communicates with the groove, mounting a motor unit in the recess so that an output member of the unit extends into the groove to engage with the rack, and connecting a window sash to the rack, so that the sash is moved longitudinally when the rack is driven along the groove by the motor.

15. A method as claimed in claim 14, wherein the window sash is only connected to the window frame along one vertical edge, the opposite vertical edge having no positive connection with the window frame.

16. A method as claimed in claim 14, wherein the rack is provided with two vertically spaced hooked brackets, and the sash is hung on those brackets.

17. A method as claimed in claim 16, wherein a peg is inserted through the window sash frame and the brackets, to prevent accidental disengagement of the sash and the brackets.

18. A method as claimed in claim 14, wherein a guide channel is mounted in the groove, and the rack is fitted in the channel for guidance therealong.

19. A method as claimed in claim 14, wherein a calibration step is carried out on completion of window installation, and thereafter the length of travel of the window sash between open and closed positions is stored by a window control unit.

20. A kit for providing motor driven opening and closing operation to a sash window, the kit comprising a toothed rack, means for connecting the rack to a vertical edge of a window sash for sliding movement with the window sash, a motor unit contained within a housing, which unit can be inset into a recess in a window frame adjacent the path of movement of the sash and the rack and having an output member in the form of a pinion adapted to engage with the rack so that operation of the motor unit rotates the pinion which in turn drives the rack in a linear path with the sash being raised or lowered as the rack is driven, and a rack guide channel for mounting in a stile of the window frame, for slidably receiving the rack.

21. A kit as claimed in claim 20, wherein hooked brackets are provided for fitting to the rack, and bracket-receiving pockets are provided for fitting in the vertical edge of a window sash.

22. A kit as claimed in claim 20, including a plurality of identical lengths of rack, with means for joining lengths end to end to make a rack longer than a single length.

23. A kit as claimed in claim 20, wherein the rack is provided with means whereby the brackets can be fixed to the rack in selected ones of a range of different possible positions.

24. A kit as claimed in claim 23, wherein the rack is provided with a series of spaced, tapped holes into which brackets can be fitted.

25. A kit as claimed in claim 20, wherein the motor unit is a preassembled, sealed unit.

26. A kit as claimed in claim 20, including a control unit with a calibration mode which enables the length of movement of the window to be stored in the control unit after window installation.

27. A kit as claimed in claim 20, adapted to be fitted to an old window.

28. A kit as claimed in claim 20, adapted to be fitted to a new window.

29. A sash window arrangement as claimed in claim 1, including a proximity detector arranged at an end position of window movement, which stops window movement if an obstruction is sensed.
